(19) United States
(12) Patent Application Publication
(10) Pub. No.: US 2026/0065581 A1
(43) Pub. Date: Mar. 5, 2026

(54) Reverse Rasterization

(71) Applicant: Apple Inc., Cupertino, CA (US)

(72) Inventors: Gregory Duquesne, San Carlos, CA (US); Carlos Gonzalez-Ochoa, Culver City, CA (US)

(21) Appl. No.: 19/304,074

(22) Filed: Aug. 19, 2025

Related U.S. Application Data
(60) Provisional application No. 63/689,362, filed on Aug. 30, 2024.

(51) Int. Cl. G06T 15/40; G06T 15/20; G06T 17/20

(52) U.S. Cl. CPC G06T 15/40; G06T 15/20; G06T 17/20

(57) ABSTRACT

Reverse rasterization may be used as a technique to reconstruct accurate lightweight 3D models from complex and/or high-fidelity 3D graphical models or scenes. The process of reverse rasterization may begin with two or more renders created from virtual camera viewpoints distributed around the 3D model or scene that is to be reconstructed. Using the various virtual camera viewpoints, a lightweight version of the complex 3D model/scene may be reconstructed, e.g., by determining which virtual camera viewpoint has the best visibility for each point on the surface of the 3D model/scene. Once the reversion rasterization process determines the virtual camera viewpoint with the best visibility to use for a given point on the reconstructed model, that point may be kept, while other pixels in the vicinity of that point may be filtered and/or deleted. Contiguous pixels are then converted to vertices and joined by triangles to form a reconstructed 3D mesh.

### TECHNICAL FIELD

This disclosure relates generally to the field of graphics processing. More particularly, but not by way of limitation, it relates to techniques for producing lightweight reconstructed models of high-fidelity three-dimensional (3D) objects and scenes.

### BACKGROUND

In professional movie and video game production environments, there are often 3D scenes or object with very complex geometry (e.g., hundreds of millions of triangles, as well as many different textures and materials). Dedicated, high-powered computer graphics workstations may have the ability to do the heavy duty 3D rendering required for such complex models, but if the same complex 3D model information is to be streamed to a device without comparable processing power (e.g., a head-mounted display (HMD) device, tablet, smartphone, or the like), such as to present a user with real-time/interactive preview and display of the 3D model, the 3D model will need to be simplified prior to such preview or interaction.

One existing way to simplify complex and/or high-fidelity 3D model information is to use photogrammetry techniques which can capture various two-dimensional (2D) photos of an object/scene and then convert the 2D photos into a lightweight 3D model. However, a major downside of photogrammetry techniques is that they can lead to a large amount of information loss, resulting in the reconstructed lightweight 3D model being low-fidelity, low resolution, blurry, and/or otherwise not an accurate representation of the original 3D model object.

Thus, there is a need for improved methods, apparatuses, computer readable media, and systems to create and render accurate and lightweight reconstructed models of high-fidelity and complex 3D graphical models of objects and scenes, wherein such reconstructed models can be previewed and/or displayed in real-time on devices with more modest computational and graphical processing power.

### SUMMARY

Devices, methods, and non-transitory program storage devices are disclosed herein to perform a so-called “reverse rasterization” process. Reverse rasterization may be used as a technique to reconstruct accurate and lightweight 3D models from complex and/or high-fidelity 3D graphical models or scenes. As will be detailed herein, the process is referred to herein as “reverse” rasterization, as it takes pixel data and converts it back into a mesh of triangles (i.e., as opposed to “normal” rasterization, which takes triangles and converts them into pixel data).

According to some embodiments, the process of reverse rasterization may begin with a number (e.g., 2 or more) of renders created from virtual camera viewpoints distributed around the 3D model or scene that is to be reconstructed. Using the various renders (also referred to herein as “rasters”) created from the various virtual camera viewpoints, a lightweight version of the complex 3D model/scene may be reconstructed, e.g., by determining which virtual camera viewpoint has the best visibility for each point on the surface of the 3D model/scene. In some embodiments, this determination may involve the computation of a so-called “visibility metric,” as will be discussed in greater detail below. Once the reversion rasterization process determines the virtual camera viewpoint with the “best visibility” to use for a given point on the reconstructed model, that point may be kept, while other pixels in the vicinity of that point may be filtered out and/or deleted.

Then, a new mesh may be reconstructed based on the determined “best visibility” renders for each pixel or viewpoint of the 3D object or scene that is being reconstructed. For example, contiguous pixels remaining from the viewpoint filtering process may then be converted to vertices and joined by triangles to form the reconstructed mesh. The properties of the newly-reconstructed lightweight mesh (e.g., 3D positions, normals, textures, etc.) can also be calculated and stored by the reverse rasterization pipeline process. As may now be appreciated, if the original, high-fidelity version of a complex 3D model or scene has hundreds of millions of triangles, reverse rasterization can generate a reconstructed and simplified 3D mesh quickly—and even stream the relevant textures to the lighter-weight processing device that is displaying and/or manipulating the reconstructed 3D mesh, while the device performing the reverse rasterization operation may continue rendering and streaming updated information to the lighter-weight processing device over time as the rendering operation continues (e.g., performing a “beauty pass” of the model data that is a progressive rendering operation that adds additional detail, such as complex lighting effects, over time).

The result of the reverse rasterization process, then, is a newly reconstructed 3D mesh that may be initially comprised of a patchwork of a plurality of different mesh surfaces (e.g., wherein each mesh surface comprises pixels/viewpoints reconstructed from a particular virtual camera viewpoint). In some embodiments, the individual patchwork of meshes may later be stitched/blended together to form a single reconstructed 3D mesh.

Other modifications to the reverse rasterization pipeline can include: breaking up a scene into layers (e.g., one layer for the environment and another layer for moving objects) and/or producing a depth map for the 3D scene, wherein each value in the depth map represents the distance from the virtual camera to the closest object surface in the 3D scene, whereafter 3D meshes can be reconstructed separately for each of the different layers; and/or continuing to render objects behind the camera's current viewpoint (e.g., using ray tracing to “see” such objects) to avoid occlusion problems or missing graphical data if the camera's viewpoint later changes and the viewer can suddenly see geometry that would normally be occluded by the primary objects in the 3D scene.

Thus, according to some embodiments, there is provided a device, comprising: a memory; a display screen; and one or more processors operatively coupled to the memory, wherein the one or more processors are configured to execute instructions causing the one or more processors to: obtain a three-dimensional (3D) graphical model; determine a first plurality of virtual camera viewpoints, wherein each of the first plurality of virtual camera viewpoints is oriented towards at least a portion of the 3D graphical model; generate a first plurality of renderings of the 3D graphical model from each of the first plurality of virtual camera viewpoints; generate a reconstructed model of the 3D graphical model based on the first plurality of renderings from each of the first plurality of virtual camera viewpoints, wherein, for each pixel of the reconstructed model, a determination is made as to which of the first plurality of virtual camera viewpoints provides the best visibility (e.g., has a highest visibility metric) of the respective pixel of the 3D graphical model.

In some embodiments, the instructions causing the one or more processors to generate a reconstructed model of the 3D graphical model based on the first plurality of renderings from each of the first plurality of virtual camera viewpoints further comprise instructions causing the one or more processors to generate a first plurality of meshes to represent the reconstructed model of the 3D graphical model. In some such embodiments, the first plurality of meshes is generated based on a contiguous set of pixels, wherein a contiguous set of pixels comprises a set of adjacent pixels for which it has been determined that a same virtual camera viewpoint provides the best visibility of the respective pixels of the reconstructed model.

In other embodiments, the one or more processors are further configured to execute instructions causing the one or more processors to stitch together at least two of the first plurality of meshes.

In still other embodiments, the one or more processors are further configured to execute instructions causing the one or more processors to generate UV mappings for the at least two stitched meshes.

In yet other embodiments, at least one of the first plurality of renderings of the 3D graphical model from each of the first plurality of virtual camera viewpoints comprises: (a) a 3D position rendering; (b) a surface normals rendering; or (c) a texture-related rendering.

Various non-transitory program storage device (NPSD) embodiments are also disclosed herein. Such NPSDs are readable by one or more processors. Instructions may be stored on the NPSDs for causing the one or more processors to perform any of the embodiments disclosed herein. Various image processing methods are also disclosed herein, in accordance with the device and NPSD embodiments disclosed herein.

### BRIEF DESCRIPTION OF THE DRAWINGS

FIG. 1 illustrates an example of a reverse rasterization processing pipeline, according to various embodiments.

FIG. 2 illustrates an example of a high-fidelity 3D model and a corresponding reconstructed lightweight mesh, according to various embodiments.

FIG. 3A illustrates an example of a plurality of virtual camera viewpoints distributed around a high fidelity 3D object model, according to various embodiments.

FIG. 3B illustrates an example of renders created from each of a plurality of virtual camera viewpoints distributed around a high fidelity 3D object model, according to various embodiments.

FIG. 3C illustrates an example of a plurality of texture-related and geometry-related renders corresponding to a particular virtual camera viewpoint directed towards a high fidelity 3D object model, according to various embodiments.

FIG. 3D illustrates an example of a first plurality of meshes used in a reconstructed model of a high fidelity 3D object model, according to various embodiments.

FIG. 4 is a flow chart illustrating a method of performing reverse rasterization, according to various embodiments.

FIG. 5 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

### Exemplary Reverse Rasterization Processing Pipeline

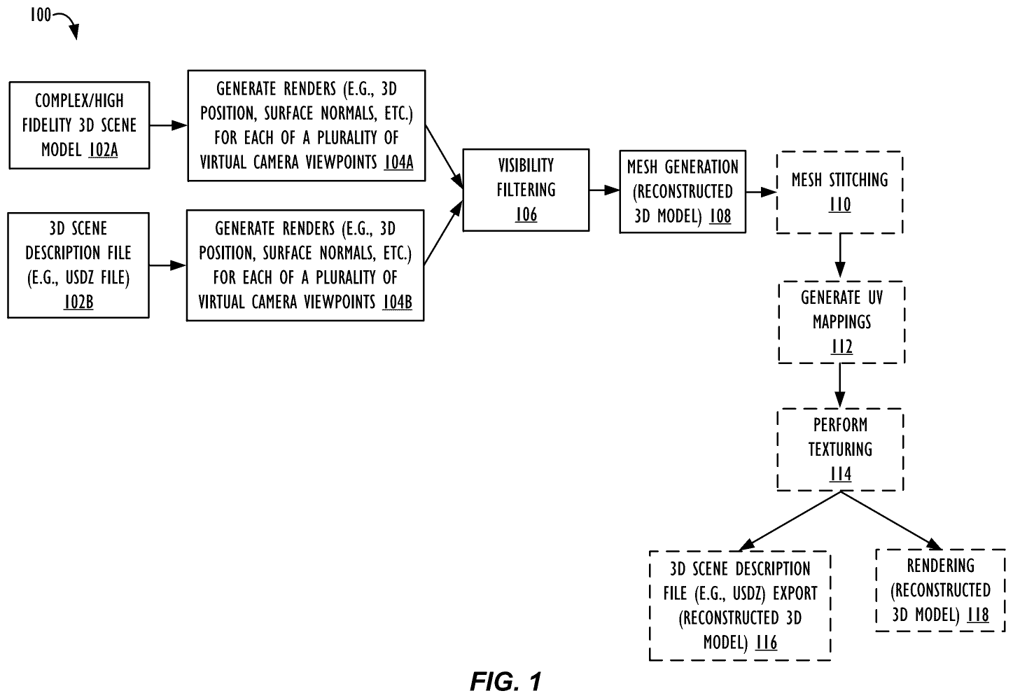

Turning now to FIG. 1, an example of a reverse rasterization processing pipeline 100 is shown, according to various embodiments. Looking first at boxes 102A and 102B, the input to a reverse rasterization processing pipeline may comprise any desired format of complex/high fidelity 3D scene model (102A) and/or a 3D scene description file, e.g., a Universal Scene Description Zip (USDZ) file (102B). Next, at boxes 104A/104B, one or more renders may be generated from each of a plurality of virtual camera viewpoints constructed around the respective 3D models, 102A/102B. As will be described in greater detail below, the renders (i.e., rasters) may comprise at least geometry-based renders, such as 3D world position renders and surface normal renders, as well as any number of desired texture-based renders, such as albedo, specularity, color, etc., which are used to describe the surface material for the reconstructed 3D model.

Next, at block 106, a process of so-called “visibility filtering” may be performed on all the various renders of the 3D scene/object created from the various virtual camera viewpoints. According to some embodiments, the process of visibility filtering may comprise assigning a “best” virtual camera viewpoint to use for visualizing each surface of the original 3D model/scene. In some embodiments, determining the best virtual camera viewpoint for visualizing a given surface in the original 3D model/scene may comprise computing a so-called “visibility metric” for each camera viewpoint that has visibility of a given surface in the original 3D model/scene. For example, according to some embodiments, the visibility metric may be computed by determining the distances between the closest point between the reconstructed 3D object model to the original 3D object model for each of the plurality of virtual camera viewpoints.

According to some embodiments, additional efficiencies may be gained by, once a first virtual camera has covered a portion of the original 3D model/scene, filtering (i.e., preventing or stopping) other virtual cameras from redundantly covering the same portion of the original 3D model/scene that has already been covered by another virtual camera's viewpoint.

Next, at block 108, one or more meshes representing the original 3D model may be created, which, when combined, form the mesh of the reconstructed version of the original 3D model. According to some embodiments, e.g., each constituent mesh may comprise the portions of the original 3D model that a particular virtual camera viewpoint had the best “visibility” of. For example, a Mesh #1 may comprise the portion of the reconstructed model generated from the virtual camera viewpoint #1, while Mesh #2 may comprise the portion of the reconstructed model generated from the virtual camera viewpoint #2, and so forth, for each virtual camera viewpoint used to generate renders of the original 3D mode.

Next, at block 110, one or more of the meshes may optionally be “stitched” together, i.e., combined, according to any desired mesh stitching technique, which may, e.g., result in the removing and/or regenerating of certain of the triangles (and/or vertices) along the boundaries between any two adjacent constituent meshes.

Next, at block 112, UV mappings may optionally be generated for the reconstructed model. As may be appreciated, UV mappings may be used for 2D texture parameterization, i.e., to support any optional texturing desired at block 114. As may be appreciated, texturing may be used to give the surface of the reconstructed model a similar coloration and/or “look-and-feel” to the corresponding portions of the original 3D model.

Finally, the reconstructed lightweight version of the original complex/high fidelity 3D model may be used as desired by any given application, e.g., saved to a new 3D scene description file (e.g., USDZ) (block 116), rendered for display (block 118), etc.

Various advantages of reverse rasterization processing techniques, such as those shown in FIG. 1, include the fact that they may be faster than traditional photogrammetry or geometric and/or volumetric-based techniques, which may involve more complex geometry generation (e.g., performing surface reconstruction from a point cloud), at 3D model reconstruction; they may use the geometric information of the original, high fidelity 3D models directly (i.e., as opposed to 2D images of the model); they don't necessarily need to create UV mappings; they have the effect of “baking out” (i.e., removing) superfluous detail from the original 3D models/scene (e.g., internal shapes and structures of the model); and they can even handle the reconstruction of thin sheets or other thin 3D structures well.

Exemplary High-Fidelity 3D Model and Reconstruction from Multiple Virtual Camera Viewpoint Rasters

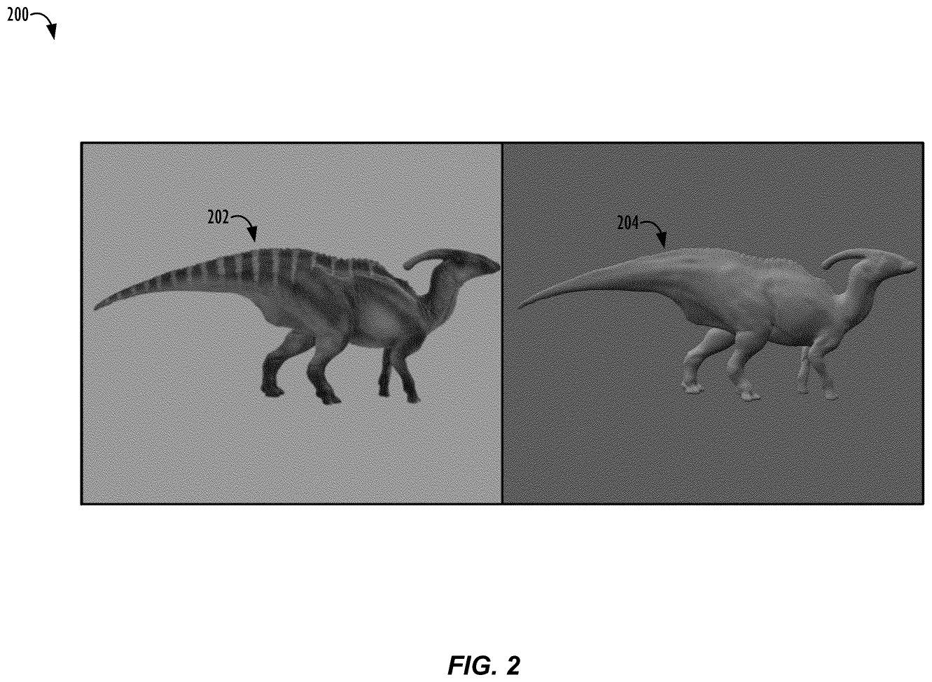

Turning now to FIG. 2, an example of a high-fidelity 3D model 202 of a dinosaur toy and a corresponding reconstructed lightweight mesh 204 version of the high-fidelity 3D model 202 is illustrated, according to various embodiments. As will be explained in further detail in the following Figures, using various renders (i.e., rasters) of the model produced by different virtual camera viewpoints oriented towards different portions of the high-fidelity 3D model 202, the reverse rasterization process may reconstruct a lightweight 3D mesh version 204 of the high-fidelity 3D model 202. According to some embodiments disclosed herein, the mesh 204 is generated, at least in part, by determining which virtual camera viewpoint has the best visibility for each point on the surface of the 3D model asset 202 (e.g., by computing a visibility metric for each point).

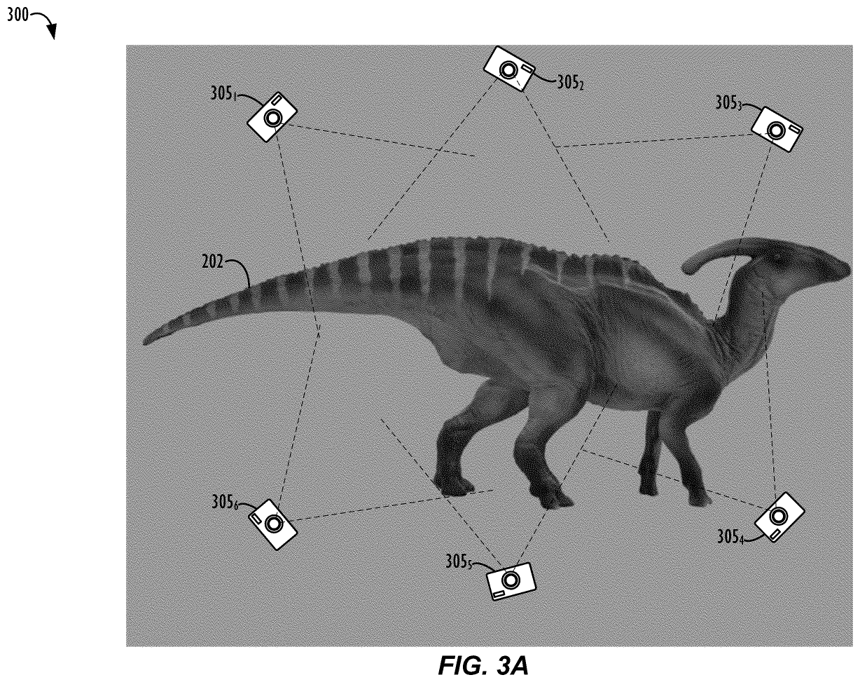

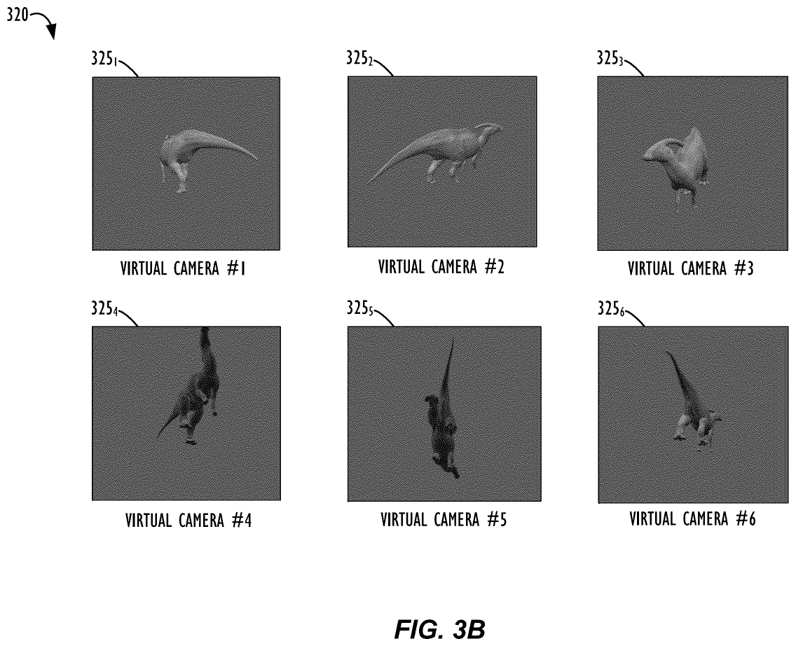

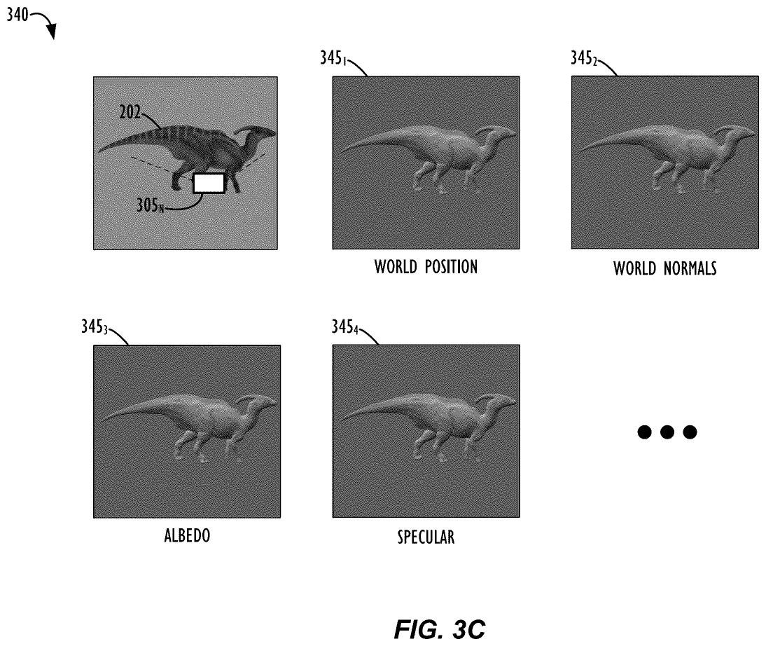

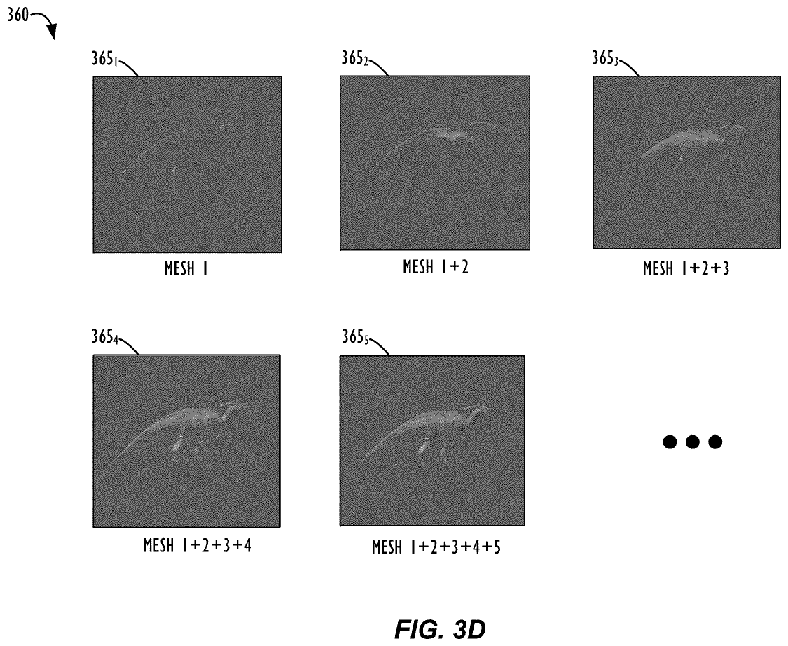

Turning now to FIG. 3A, an example 300 of a plurality of virtual camera viewpoints 305₁-305₆ distributed around a high fidelity 3D object model 202 is illustrated, according to various embodiments. It is to be understood that the precise placements of the virtual camera viewpoints 305 (as well as their exact number) in FIG. 3A is merely illustrative, and different implementations could use different numbers of virtual camera viewpoints and/or distribute said virtual camera viewpoints 305 around the high fidelity 3D object model 202 differently before generating the corresponding rendering(s) (i.e., raster(s)) from each such virtual camera viewpoint. Preferably, the virtual camera viewpoints 305 are distributed relatively evenly and each oriented towards at least a portion of the high fidelity 3D object model 202, such that there is visibility to all parts of the high fidelity 3D object model 202 by at least one virtual camera viewpoint 305, whose output will be used, at least in part, in the generation of a lightweight reconstruction of the original high fidelity 3D object model 202.

Turning next to FIG. 3B, an example 320 of various renders from a plurality of virtual camera viewpoints 325₁-325₆ created from each a plurality of virtual camera viewpoints plurality of virtual camera viewpoints 305₁-305₆ distributed around a high fidelity 3D object model 202 is illustrated, according to various embodiments. In this example 320, the render from virtual camera viewpoint #1 325₁ is meant to correspond to the view of the original high fidelity 3D object model 202 as captured by virtual camera viewpoint 305₁, while the render from virtual camera viewpoint #2 325₂ is meant to correspond to the view of the original high fidelity 3D object model 202 as captured by virtual camera viewpoint 305₂, and so forth. As mentioned above with reference to FIG. 3A, the use of six virtual camera viewpoints at the six particular locations shown in FIG. 3A is merely illustrative for this example, and more (or fewer) virtual camera viewpoints could be used, in a given implementation.

Turning next to FIG. 3C, an example 340 of a plurality of texture-related and geometry-related renders 345₁-345₄ corresponding to an exemplary particular virtual camera viewpoint 305_{N} directed towards a high fidelity 3D object model 202 is illustrated, according to various embodiments. In this example 340, the exemplary virtual camera viewpoint 305_{N} is directed towards the right side of the high fidelity 3D object model 202. The exemplary render 345₁ represents an exemplary geometry-related “world position” render, wherein, e.g., the colors of the pixels in the render 345₁ may be representative of the x, y, and z-coordinates of the corresponding pixel of the model in world space. Similarly, the exemplary render 345₂ represents an exemplary geometry-related “world normals” render, wherein, e.g., the colors of the pixels in the render 345₂ may be representative of the x, y, and z values of the normal vector of the corresponding pixel of the model in world space.

The exemplary render 345₃ represents an exemplary texture-based “albedo” render, wherein, e.g., the colors of the pixels in the render 345₃ may be representative of the virtual camera viewpoint that the albedo properties of the corresponding pixel of the model in world space are determined from, and exemplary render 345₄ represents an exemplary texture-based “specular” render, wherein, e.g., the colors of the pixels in the render 345₄ may be representative of the virtual camera viewpoint that the specular properties of the corresponding pixel of the model in world space are determined from. It is to be understood that many additional texture-and/or geometry-related renders may be created from each virtual camera viewpoint. In some embodiments, because the various renders 345 may correspond to any arbitrary value related to the original model (e.g., any type of value that can be measured on the surface of a rendered object), they may also be referred to as “AOVs,” or arbitrary output variables.

Turning next to FIG. 3D, an example 360 of a first plurality of meshes 365₁-365₅ used in a reconstructed model of a high fidelity 3D object model 202 is illustrated, according to various embodiments. Exemplary mesh 365₁ represents the portion of the overall reconstructed mesh model of the original high fidelity 3D object model 202 that came from an exemplary first virtual camera viewpoint. Exemplary mesh 365₂ builds upon mesh 365₁ and represents the union of the portions of the overall reconstructed mesh model of the original high fidelity 3D object model 202 that came from the exemplary first virtual camera viewpoint and an exemplary second virtual camera viewpoint.

This process of illustrating the inclusion of meshes generated from a particular virtual camera viewpoint is continued with exemplary mesh 365₃ representing the union of first, second, and third virtual camera viewpoints, exemplary mesh 365₄ representing the union of first, second, third, and fourth virtual camera viewpoints, and exemplary mesh 365₅ representing the union of first, second, third, fourth, and fifth virtual camera viewpoints, and so forth. It is to be understood that, once the portions of the overall reconstructed mesh model obtained from each virtual camera viewpoint that is being used in the reverse rasterization process are combined (and, optionally, stitched together), the resulting combined mesh would represent the full reconstructed lightweight model of the original high fidelity 3D object model 202. FIG. 3D merely serves an illustrate purpose, i.e., to demonstrate that different portions of the reconstructed model may be “sourced” from different virtual camera viewpoints.

### Exemplary Methods for Performing Reverse Rasterization

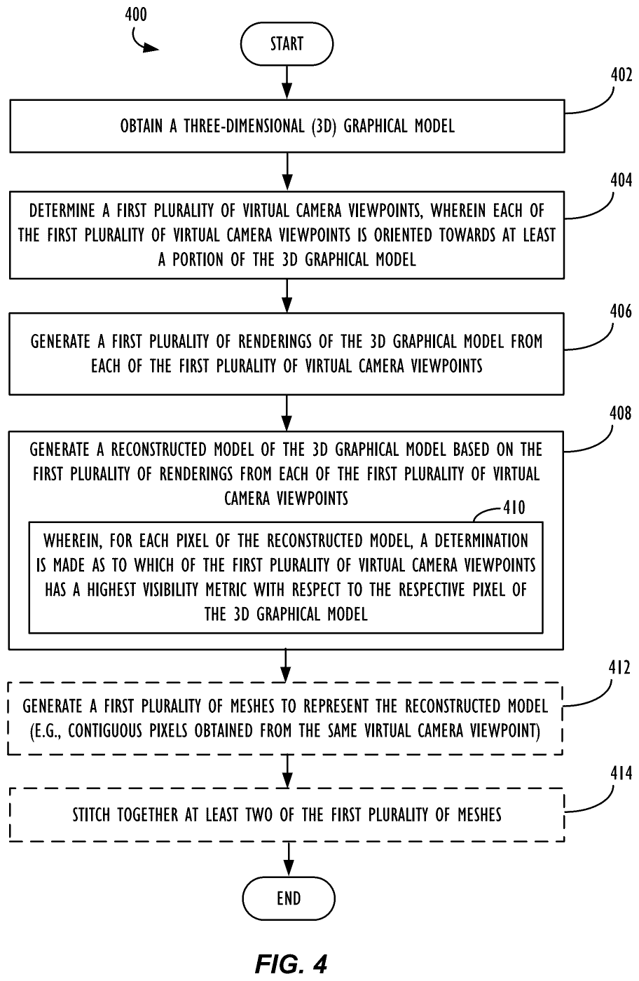

FIG. 4 is a flow chart illustrating a method 400 of performing reverse rasterization, according to various embodiments. First, at Step 402, the method 400 may obtain a three-dimensional (3D) graphical model, e.g., a high fidelity and/or complex 3D model of an object or scene, which may be difficult to render or display in full detail and/or in real-time on a device with lightweight processing power, such as an HMD device, tablet, smartphone, or other consumer electronic device.

Next, at Step 404, the method 400 may determine a first plurality of virtual camera viewpoints, wherein each of the first plurality of virtual camera viewpoints is oriented towards at least a portion of the 3D graphical model, e.g., as illustrated and discussed above with reference to FIG. 3B.

Next, at Step 406, the method 400 may generate a first plurality of renderings of the 3D graphical model (e.g., one or more of a 3D position rendering, a surface normals rendering, or a texture-related rendering) from each of the first plurality of virtual camera viewpoints.

Next, at Step 408, the method 400 may generate a reconstructed model of the 3D graphical model based on the first plurality of renderings from each of the first plurality of virtual camera viewpoints. According to some such embodiments, at Step 410, the method 400 may make, for each pixel of the reconstructed model, a determination as to which of the first plurality of virtual camera viewpoints has the best visibility (e.g., has a highest visibility metric) with respect to the respective pixel of the original (e.g., high fidelity) 3D graphical model. As may now be appreciated, the end result of determining the virtual camera viewpoint that has the highest visibility metric for each pixel of the reconstructed model is the generation of the aforementioned reconstructed model of the original 3D graphical model.

Next, at Step 412, the method 400 may optionally generate a first plurality of meshes to represent the reconstructed model (e.g., wherein each mesh comprises a set of contiguous pixels that were obtained from the same virtual camera viewpoint).

Finally, at Step 414, the method 400 may optionally stitch together at least two of the first plurality of meshes, thereby creating the finalized reconstructed model of the original complex 3D graphical model. As mentioned above, if desired, one or more additional texture-related renderings may also be applied to the respective constituent meshes making up the reconstructed model, thereby giving the reconstructed model a similar “look-and-feel” to the original complex 3D graphical model.

It is to be understood that one or more of the steps described above with reference to method 400 may be performed in a different order, if so desired, for a given implementation. Moreover, additional optional steps may be performed as a part of method 400, depending on the needs and fidelity/accuracy required for the reconstructed model in a given implementation.

### Exemplary Electronic Computing Devices

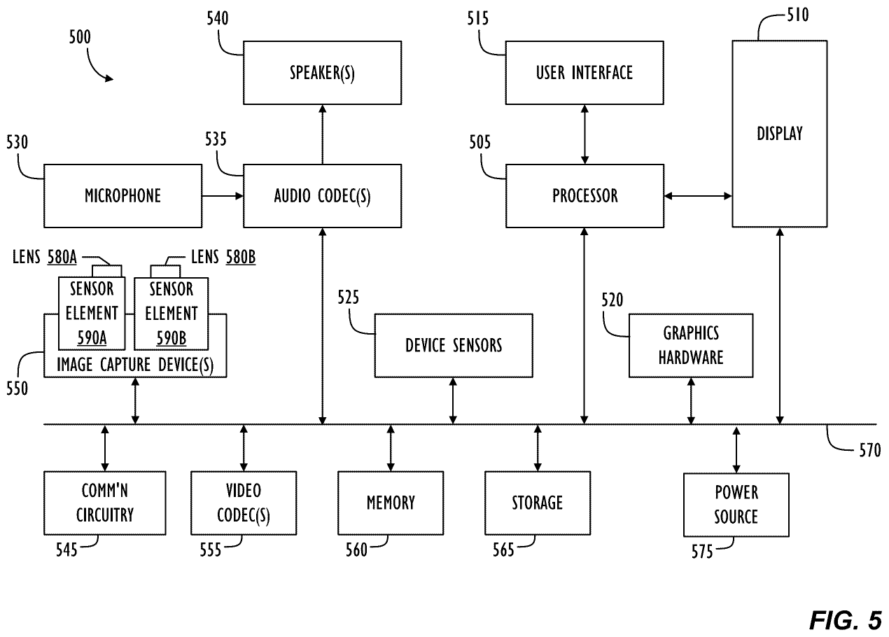

Referring now to FIG. 5, a simplified functional block diagram of illustrative programmable electronic computing device 500 is shown according to one embodiment. Electronic device 500 could be, for example, a mobile telephone, personal media device (e.g., a head-mounted display (HMD) device or other wearable), portable camera, or a tablet, notebook or desktop computer system. As shown, electronic device 500 may include processor 505, display 510, user interface 515, graphics hardware 520, device sensors 525 (e.g., proximity sensors/ambient light sensors/motion detectors/LiDAR sensors/depth sensors, accelerometers, inertial measurement units, gyroscopes, and/or other types of sensors), microphone 530, audio codec(s) 535, speaker(s) 540, communications circuitry 545, image capture device(s) 550, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 555, memory 560, storage 565, and communications bus 570.

Processor 505 may execute instructions necessary to carry out or control the operation of many functions performed by electronic device 500 (e.g., such as the processing of graphical data in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 510 may display a video stream as it is captured while processor 505 and/or graphics hardware 520 and/or image capture circuitry contemporaneously generate and store the video stream in memory 560 and/or storage 565. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 550 may comprise one or more camera units configured to capture images, e.g., images which may be processed to help further improve the efficiency of VIS operations, e.g., in accordance with this disclosure. Image capture device(s) 550 may include two (or more) lens assemblies 580A and 580B, where each lens assembly may have a separate focal length. For example, lens assembly 580A may have a shorter focal length relative to the focal length of lens assembly 580B. Each lens assembly may have a separate associated sensor element, e.g., sensor elements 590A/590B. Alternatively, two or more lens assemblies may share a common sensor element. Image capture device(s) 550 may capture still and/or video images. Output from image capture device(s) 550 may be processed, at least in part, by video codec(s) 555 and/or processor 505 and/or graphics hardware 520, and/or a dedicated image processing unit or image signal processor incorporated within image capture device(s) 550. Images so captured may be stored in memory 560 and/or storage 565.

Memory 560 may include one or more different types of media used by processor 505, graphics hardware 520, and image capture device(s) 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory;
a display screen; and
one or more processors operatively coupled to the memory, wherein the one or more processors are configured to execute instructions causing the one or more processors to:
obtain a three-dimensional (3D) graphical model;
determine a first plurality of virtual camera viewpoints, wherein each of the first plurality of virtual camera viewpoints is oriented towards at least a portion of the 3D graphical model;
generate a first plurality of renderings of the 3D graphical model from each of the first plurality of virtual camera viewpoints; and
generate a reconstructed model of the 3D graphical model based on the first plurality of renderings from each of the first plurality of virtual camera viewpoints,
wherein, for each pixel of the reconstructed model, a determination is made as to which of the first plurality of virtual camera viewpoints has a highest visibility metric of the respective pixel of the 3D graphical model.

2. The device of claim 1, wherein the instructions causing the one or more processors to generate a reconstructed model of the 3D graphical model based on the first plurality of renderings from each of the first plurality of virtual camera viewpoints further comprise instructions causing the one or more processors to:
generate a first plurality of meshes to represent the reconstructed model of the 3D graphical model.

3. The device of claim 2, wherein each mesh of the first plurality of meshes is generated based on a contiguous set of pixels.

4. The device of claim 3, wherein a contiguous set of pixels comprises a set of adjacent pixels for which it has been determined that a same virtual camera viewpoint provides the best visibility of the respective pixels of the reconstructed model.

5. The device of claim 2, wherein the one or more processors are further configured to execute instructions causing the one or more processors to:
stitch together at least two of the first plurality of meshes.

6. The device of claim 5, wherein the one or more processors are further configured to execute instructions causing the one or more processors to:
generate UV mappings for the at least two stitched meshes.

7. The device of claim 1, wherein at least one of the first plurality of renderings of the 3D graphical model from each of the first plurality of virtual camera viewpoints comprises: (a) a 3D position rendering; or (b) a surface normals rendering.

8. The device of claim 1, wherein at least one of the first plurality of renderings of the 3D graphical model from each of the first plurality of virtual camera viewpoints comprises: a texture-related rendering.

9. A non-transitory program storage device comprising instructions stored thereon to cause one or more processors to:
obtain a three-dimensional (3D) graphical model;
determine a first plurality of virtual camera viewpoints, wherein each of the first plurality of virtual camera viewpoints is oriented towards at least a portion of the 3D graphical model;
generate a first plurality of renderings of the 3D graphical model from each of the first plurality of virtual camera viewpoints; and
generate a reconstructed model of the 3D graphical model based on the first plurality of renderings from each of the first plurality of virtual camera viewpoints,
wherein, for each pixel of the reconstructed model, a determination is made as to which of the first plurality of virtual camera viewpoints has a highest visibility metric of the respective pixel of the 3D graphical model.

10. The non-transitory program storage device of claim 9, wherein the instructions causing the one or more processors to generate a reconstructed model of the 3D graphical model based on the first plurality of renderings from each of the first plurality of virtual camera viewpoints further comprise instructions causing the one or more processors to:
generate a first plurality of meshes to represent the reconstructed model of the 3D graphical model.

11. The non-transitory program storage device of claim 10, wherein each mesh of the first plurality of meshes is generated based on a contiguous set of pixels.

12. The non-transitory program storage device of claim 11, wherein a contiguous set of pixels comprises a set of adjacent pixels for which it has been determined that a same virtual camera viewpoint provides the best visibility of the respective pixels of the reconstructed model.

13. The non-transitory program storage device of claim 10, wherein the one or more processors are further configured to execute instructions causing the one or more processors to:
stitch together at least two of the first plurality of meshes.

14. The non-transitory program storage device of claim 13, wherein the one or more processors are further configured to execute instructions causing the one or more processors to:
generate UV mappings for the at least two stitched meshes.

15. The non-transitory program storage device of claim 9, wherein at least one of the first plurality of renderings of the 3D graphical model from each of the first plurality of virtual camera viewpoints comprises: (a) a 3D position rendering; or (b) a surface normals rendering.

16. The non-transitory program storage device of claim 9, wherein at least one of the first plurality of renderings of the 3D graphical model from each of the first plurality of virtual camera viewpoints comprises: a texture-related rendering.

17. An image processing method, comprising:
obtaining a three-dimensional (3D) graphical model;
determining a first plurality of virtual camera viewpoints, wherein each of the first plurality of virtual camera viewpoints is oriented towards at least a portion of the 3D graphical model;
generating a first plurality of renderings of the 3D graphical model from each of the first plurality of virtual camera viewpoints; and
generating a reconstructed model of the 3D graphical model based on the first plurality of renderings from each of the first plurality of virtual camera viewpoints,
wherein, for each pixel of the reconstructed model, a determination is made as to which of the first plurality of virtual camera viewpoints has a highest visibility metric of the respective pixel of the 3D graphical model.

18. The method of claim 17, further comprising:
generating a first plurality of meshes to represent the reconstructed model of the 3D graphical model.

19. The method of claim 18, further comprising:
stitching together at least two of the first plurality of meshes.

20. The method of claim 17, wherein at least one of the first plurality of renderings of the 3D graphical model from each of the first plurality of virtual camera viewpoints comprises: (a) a 3D position rendering; (b) a surface normals rendering; or (c) a texture-related rendering.
